(19) United States
(12) Patent Application Publication
(10) Pub. No.: US 2019/0367770 A1
(43) Pub. Date: Dec. 5, 2019

(54) PROCESS FOR PRODUCING RIGID POLYURETHANE (PUR) AND POLYURETHANE/ POLYISOCYANURATE (PUR/PIR) FOAMS

(71) Applicant: Covestro Deutschland AG, Leverkuse (JP)

(72) Inventors: Dirk Brüning, Leverkusen (DE); Achim Symannek, Leichlingen (DE); Stephan Schleiermacher, Pulheim (DE); Dirk Steinmeister, Leverkusen (DE); Catherine Loevenich, Bergisch Gladbach (DE); Nicole Welsch, Köln (DE)

(21) Appl. No.: 16/467,767

(22) PCT Filed: Jan. 30, 2018
(86) PCT No.: PCT/EP2018/052224

§ 371 Date: Jun. 7, 2019

(30) Foreign Application Priority Data
Jan. 31, 2017 (EP) 17154063.6

(51) Int. Cl. C09D 175/06; C08G 18/76; C08G 18/42; C08G 18/22; C08G 18/18; C08G 18/16; C08J 9/14; C09D 5/02; B05D 1/30

(52) U.S. Cl. CPC C09D 175/06; C08G 18/7664; C08G 18/4211; C08G 18/225; C08G 18/1816; C08G 2101/0025; C08J 9/144; C08J 9/141; C09D 5/021; B05D 1/305; C08G 18/163

(57) ABSTRACT

The invention relates to a process for producing rigid polyurethane (PUR) and polyurethane/polyisocyanurate (PUR/PIR) foams, comprising the steps of i) producing a reaction mixture containing the components A) an isocyanate-reactive component, B) a polyisocyanate component, and C) a blowing agent, and ii) applying the reaction mixture by using a system comprising at least one casting device. The casting device (100) having: a supply port (12) for feeding the reaction mixture (10), at least one discharge gap (13) extending in a transverse direction (Q) for the discharge of the reaction mixture (10), two gap-forming plates (14) arranged opposite one another, a gap space (15) extending between the gap-forming plates (14) above the discharge gap (13) in a height direction (H), wherein the reaction mixture can be introduced into the gap space (15), distributed over the length of the supply duct (16).

The invention relates to a process for producing polyurethane (PUR) and polyurethane/polyisocyanurate (PUR/PIR) rigid foams comprising the steps of

i) producing a reaction mixture containing the components
A) an isocyanate-reactive component containing at least one polyol selected from the group consisting of polyether polyols, polyester polyols, polycarbonate polyols, polyether-polycarbonate polyols and polyether ester polyols,
B) a polyisocyanate component and
C) a blowing agent
D) optionally a catalyst component
E) optionally assistant and additive substances,
   ii) applying the reaction mixture using a curtain coating apparatus, wherein the curtain coating apparatus comprises a feed connection for introducing the reaction mixture and forms a discharge slot extending in a transverse direction for discharging the reaction mixture and wherein the curtain coating apparatus comprises two opposing slot plates wherein a slot space extends between the slot plates in a vertical direction above the discharge slot.

EP 2 216 156 A1 discloses a continuous process for producing composite elements, comprising a lower outerlayer, a foam core and an upper outerlayer, wherein a foamable reaction mixture is applied using a curtain coating apparatus comprising a plurality of discharge conduits.

The quality of the sandwich elements depends essentially on how uniformly the polyurethane foam core is formed between the two outerlayers and how well it fills the volume. The adhesion of the outerlayers to the interface of the polyurethane foam core also plays a significant role in assessing the quality of the composite element. If two or more strands of reaction mixture are applied onto the inside of the outerlayer side-by-side over the width of the outerlayer foaming of the reaction mixture leads to multiple foam fronts which come into lateral contact with one another and which thus have interfaces forming between them. This results in a nonuniform foaming of the reaction mixture with a plurality of foam fronts and in the cured state the polyurethane foam core has an inhomogeneous texture. Overlapping areas with bubbles and voids are formed and the cell orientation of the foam is generally nonuniform too. This reduces the quality of the foam structure and may result in insufficient adhesion to the inside of the outerlayers, thus potentially leading to a reduced quality of the composite elements, in particular in respect of mechanical and/or thermal properties, surface quality and/or compressive strength.

EP 0 683 027 A discloses a process for applying molten or liquid polymer foam using a broad slot die, wherein the polymer is initially mixed with gas, the mixture passes through the distributor region (68) above a critical pressure and the mixture is subsequently decompressed to expand the gas and thus bring about foaming of the polymer. However, this document does not disclose a process for applying a reactive mixture in which gas is formed during the reaction. The described broad slot die is moreover not advantageously suitable for applying a reactive polyol-polyisocyanate mixture since the disclosed distributor channel has a right angle cross section of constant height (W) over the length of the discharge slot of the curtain coating apparatus. The thickness (H) of the distributor channel decreases sharply from the feed connection outward. The ratio of the cross sectional area of the channel to the circumference—typically referred to as hydraulic diameter—thus becomes ever smaller, causing increased blockage of the distributor channel at the channel end due to the wall adhesion of the reactive mixture and the decreasing velocity. In EP 0 683 027 A further slot regions (71), (72) and (73) are provided downstream of the distributor region (68), thus resulting in the mixture requiring more time to pass through the curtain coating apparatus which is critical in particular for reactive polyol-polyisocyanate mixtures. The edge ratio of the right angle cross section specified in EP 0 683 027 A moreover has the result that passing through the curtain coating apparatus requires differing amounts of time depending on the flow path, thus resulting in nonuniform foaming of the reaction mixture. Furthermore, the disclosed cross sectional widening in the slot region (71) can result in stagnation of the mixture and thus increased blockage due to the progressing reaction of the mixture.

GB 1 282 876 A discloses a curtain coating apparatus comprising a broad slot die allowing application of lines of a reaction mixture comprising polyol and isocyanate oriented along the width of the outerlayer. In this curtain coating apparatus a plurality of feed connections open punctately into a slot space which is formed between the slot plates and in segments has a triangular shape. However, the triangular geometry of the slot space of this curtain coating apparatus does not allow each unit volume of the reaction mixture to pass through the curtain coating apparatus in the same time since the reaction mixture achieves a shorter passthrough time directly below the feed connection than in the edge regions of the slot.

A further disadvantage is that the triangular shape formed between the slot plates does not allow a uniform discharge speed of the reaction mixture out of the discharge slot to be established, since due to the longer flow path in the edge region of the triangular structure of the slot spaces a higher pressure drop prevails than in the middle. This results in a discharge amount along the lower base edge of each of the triangular coating slots which is nonuniform over the width of the slot and thus in nonuniform foaming of the reaction mixture along the discharge slot.

EP 2 208 599 A1 discloses a process for applying a foaming polyurethane reaction mixture containing a low-boiling gas by means of a curtain coating apparatus having a slot die which is said in particular to prevent blockage of the slot die during application. To achieve this object EP 2 208 599 A1 proposes a process in which the slot space is cooled to a temperature below a certain value (T1) and deposits are thus removed by regular gas formation. EP 2 208 599 A1 further discloses different slot geometries, in particular those where the width of the slot and also the volume flow increase in the outward direction. However, this document does not disclose an embodiment where the cross section of the feed channel which closes the slot space above the discharge slot in the vertical direction narrows in the outward direction with increasing distance from the feed connection and is thus modified such that each unit volume of the reaction mixture passes through the curtain coating apparatus in the same time. This makes it possible to reduce blockage of the slot die from the outset. Moreover, the longer flow path from the feed connection toward the outside compared to the central position has the result that the discharge amount itself becomes less toward the edge even with a constant slot geometry. Composite elements of the type of interest here are also known as sandwich elements or insulation panels and are generally used as building elements for soundproofing, insulation, for commercial buildings or for façade construction. The outerlayers may be formed for example by rolls of metal or plastics or particleboards of up to 7 mm in thickness depending on the application of the composite elements. The one or two outerlayers may in each case be a flexible outerlayer, for example made of an aluminum foil, paper, multilayer outerlayers made of paper and aluminum or of mineral nonwovens and/or a rigid outerlayer, for example made of sheet steel or particleboard.

The present invention has for its object to provide a process for producing polyurethane (PUR) and polyurethane/polyisocyanurate (PUR/PIR) rigid foams by which a uniform foaming of the reaction mixture of polyol component, polyisocyanate component, blowing agent components, optionally catalysts and further assistant and additive substances shall be achieved over the width of the outerlayer. The process shall be flexibly employable also for use of rapidly reacting reaction systems. The produced rigid foams shall have properties at least as good as rigid foams produced with conventional processes (for example using a rake applicator), preferably better qualities, in particular in respect of surface quality and homogeneity of the foams.

Said object was achieved by providing a process for producing polyurethane (PUR) and polyurethane/polyisocyanurate (PUR/PIR) rigid foams comprising the steps of

i) producing a reaction mixture containing the components
A) an isocyanate-reactive component containing at least one polyol selected from the group consisting of polyether polyols, polyester polyols, polycarbonate polyols, polyether-polycarbonate polyols and polyether ester polyols,
B) a polyisocyanate component and
C) a blowing agent
D) optionally a catalyst component
E) optionally assistant and additive substances,
   ii) applying the reaction mixture with a plant comprising at least one curtain coating apparatus, wherein the curtain coating apparatus comprises a feed connection for introducing the reaction mixture and forms a discharge slot extending in a transverse direction for discharging the reaction mixture and wherein the curtain coating apparatus comprises two opposing slot plates wherein a slot space extends between the slot plates in a vertical direction above the discharge slot.

The process is in particular a continuous process.

The isocyanate-reactive component A) contains at least one base polyol component selected from the group consisting of polyether polyols, polyester polyols, polyether ester polyols, polycarbonate polyols and/or polyether-polycarbonate polyols.

This base polyol component preferably has functionalities of ≥1.2 to ≤3.5, in particular ≥1.6 to ≤2.4 and has a hydroxyl number between 100 to 300 mg KOH/g, preferably 150 to 270 mg KOH/g and especially preferably 160-260 mg KOH/g. The base polyol component preferably has more than 70 mol %, preferably more than 80 mol %, in particular more than 90 mol %, of primary OH groups.

The proportion of base polyol component based on the total weight of the isocyanate-reactive component A), the catalyst component D) and the assistant and additive substances E) is at least 50% by weight and preferably 65% by weight.

In the context of the present invention the number-average molar mass Mₙ (also known as molecular weight) is determined by gel permeation chromatography according to DIN 55672-1 of August 2007.

The “hydroxyl number” indicates the amount of potassium hydroxide in milligrams which is equivalent in an acetylation to the acetic acid quantity bound by one gram of substance. In the context of the present invention said number is determined according to the standard DIN 53240-2 (1998).

In the context of the present invention the “acid number” is determined according to the standard DIN EN ISO 2114:2002-06.

In the context of the present invention “functionality” describes the theoretical average functionality (number of isocyanate-reactive or polyol-reactive functions in the molecule) calculated from the known input materials and their quantity ratios.

In the context of this application “a polyether polyol” may also be a mixture of different polyether polyols, wherein in this case the mixture of the polyether polyols in its entirety has the recited OH number. This applies analogously to the further herein-recited polyols and their indices.

Also employable in the isocyanate-reactive component A) in addition to the abovedescribed polyols of the base polyol component are further isocyanate-reactive components:

The addition of long-chain polyols, in particular polyether polyols, can bring about an improvement in the flowability of the reaction mixture and in the emulsifiability of the blowing agent-containing formulation. For the production of composite elements with the process according to the invention these can allow continuous production of elements with flexible or rigid outerlayers.

These long-chain polyols have functionalities of ≥1.2 to ≤3.5 and have a hydroxyl number between 10 and 100 mg KOH/g, preferably between 20 and 50 mg KOH/g. They comprise more than 70 mol %, preferably more than 80 mol %, in particular more than 90 mol %, of primary OH groups. The long-chain polyols are preferably polyether polyols having functionalities of ≥1.2 to ≤3.5 and have a hydroxyl number between 10 and 100 mg KOH/g.

The addition of medium-chain polyols, in particular polyether polyols, and low molecular weight isocyanate-reactive compounds can bring about an improvement in the adhesion and dimensional stability of the resulting foam. For the production of composite elements with the process according to the invention these medium-chain polyols can allow continuous production of elements with flexible or rigid outerlayers. The medium-chain polyols, which are in particular polyether polyols, have functionalities of ≥2 to ≤6 and have a hydroxyl number between 300 and 700 mg KOH/g.

The polyethers employed in accordance with the invention as the base polyol or as the long-chain or medium-chain polyether polyols additionally present in the component A) are the polyether polyols having the recited features which are employable in polyurethane synthesis and are known to those skilled in the art.

Employable polyether polyols include for example polytetramethylene glycol polyethers such as are obtainable by polymerization of tetrahydrofuran by cationic ring opening.

Likewise suitable polyether polyols are addition products of styrene oxide, ethylene oxide, propylene oxide, butylene oxide and/or epichlorohydrin onto di- or polyfunctional starter molecules. The addition of ethylene oxide and propylene oxide is especially preferred. Suitable starter molecules are for example water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, bisphenols, in particular 4,4′-methylenebisphenol, 4,4′-(1-methylethylidene)bisphenol, 1,4-butanediol, 1,6-hexanediol and low molecular weight hydroxyl-containing esters of such polyols with dicarboxylic acids and oligoethers of such polyols.

Suitable polyester polyols are inter alia polycondensates of di- and also tri- and tetraols and di- and also tri- and tetracarboxylic acids or hydroxycarboxylic acids or lactones. Also employable instead of the free polycarboxylic acids are the corresponding polycarboxylic anhydrides or corresponding polycarboxylic esters of lower alcohols to prepare the polyesters.

Examples of suitable diols are ethylene glycol, butylene glycol, diethylene glycol, triethylene glycol, polyalkylene glycols such as polyethylene glycols and also 1,2-propanediol, 1,3-propanediol, 1,3-butanediol, 1,4-butanediol, 1,6-hexanediol and isomers, neopentyl glycol or neopentyl glycol hydroxypivalate. Also employable in addition are polyols such as trimethylolpropane, glycerol, erythritol, pentaerythritol, trimethylolbenzene or trishydroxyethyl isocyanurate.

Additional co-use of monohydric alkanols is also possible.

Examples of polycarboxylic acids that may be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. It is also possible to use the corresponding anhydrides as an acid source.

Additional co-use of monocarboxylic acids such as benzoic acid and alkanecarboxylic acids is also possible.

Hydroxycarboxylic acids that may be co-used as co-reactants in the production of a polyester polyol having terminal hydroxyl groups include hydroxycaproic acid, hydroxybutyric acid, hydroxydecanoic acid, hydroxystearic acid and the like. Suitable lactones include caprolactone, butyrolactone and homologs.

Suitable compounds for producing the polyester polyols also include in particular bio-based starting materials and/or derivatives thereof, for example castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified fatty acids and epoxidized fatty acids and fatty acid esters, for example based on myristoleic acid, palmitoleic acid, oleic acid, vaccenic acid, petroselic acid, gadoleic acid, erucic acid, nervonic acid, linoleic acid, alpha- and gamma-linolenic acid, stearidonic acid, arachidonic acid, timnodonic acid, clupanodonic acid and cervonic acid. Especially preferred are esters of ricinoleic acid with polyfunctional alcohols, for example glycerol. Also preferred is the use of mixtures of such bio-based acids with other carboxylic acids, for example phthalic acids.

The polyester polyols of the base polyol component preferably have an acid number of 0-5 mg KOH/g. This ensures that blocking of aminic catalysts by conversion into ammonium salts takes place only to a limited extent and the reaction kinetics of the foaming reaction are impaired only to a small extent.

Polycarbonate polyols that may be used are hydroxyl-containing polycarbonates, for example polycarbonate diols. These are formed in the reaction of carbonic acid derivatives, such as diphenyl carbonate, dimethyl carbonate or phosgene, with polyols, preferably diols.

Examples of such diols are ethylene glycol, propane-1,2- and -1,3-diol, butane-1,3- and -1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenols and lactone-modified diols of the abovementioned type.

Also employable instead of or in addition to pure polycarbonate diols are polyether-polycarbonate diols obtainable for example by copolymerization of alkylene oxides, such as for example propylene oxide, with CO2.

Employable polyether ester polyols are compounds containing ether groups, ester groups and OH groups. Organic dicarboxylic acids having up to 12 carbon atoms are suitable for producing the polyether ester polyols, preferably aliphatic dicarboxylic acids having ≥4 to ≤6 carbon atoms or aromatic dicarboxylic acids used singly or in admixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. Also employable in addition to organic dicarboxylic acids are derivatives of these acids, for example their anhydrides and also their esters and monoesters with low molecular weight monofunctional alcohols having ≥1 to ≤4 carbon atoms. The use of proportions of the abovementioned bio-based starting materials, in particular of fatty acids/fatty acid derivatives (oleic acid, soybean oil etc.) is likewise possible and can have advantages, for example in respect of storage stability of the polyol formulation, dimensional stability, fire characteristics and compressive strength of the foams.

Polyether polyols obtained by alkoxylation of starter molecules such as polyhydric alcohols are a further component used for producing polyether ester polyols. The starter molecules are at least difunctional, but may optionally also contain proportions of higher-functional, in particular trifunctional, starter molecules.

Starter molecules include for example diols having number-average molecular weights Mn of preferably ≥18 g/mol to ≤400 g/mol, preferably of ≥62 g/mol to ≤200 g/mol, such as 1,2-ethanediol, 1,3-propanediol, 1,2-propanediol, 1,4-butanediol, 1,5-pentenediol, 1,5-pentanediol, neopentyl glycol, 1,6-hexanediol, 1,7-heptanediol, 1,8-octanediol, 1,10-decanediol, 2-methyl-1,3-propanediol, 2,2-dimethyl-1,3-propanediol, 3-methyl-1,5-pentanediol, 2-butyl-2-ethyl-1,3-propanediol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomeric mixtures of alkylene glycols, such as diethylene glycol. Starter molecules having functionalities distinct from OH may also be employed alone or in admixture.

In addition to the diols compounds having >2 Zerewitinoff-active hydrogens, in particular having number-average functionalities of >2 to ≤8, in particular of ≥3 to ≤6, may also be co-used as starter molecules for producing the polyethers, for example 1,1,1-trimethylolpropane, triethanolamine, glycerol, sorbitan and pentaerythritol and also triol- or tetraol-started polyethylene oxide polyols having average molar masses Mn of preferably ≥62 g/mol to ≤400 g/mol, in particular of ≥92 g/mol to ≤200 g/mol.

Polyether ester polyols may also be produced by alkoxylation, in particular by ethoxylation and/or propoxylation, of reaction products obtained by the reaction of organic dicarboxylic acids and their derivatives and components with Zerewitinoff-active hydrogens, in particular diols and polyols. Derivatives of these acids that may be used include, for example, their anhydrides, for example phthalic anhydride.

Production processes of the polyols are described for example by Ionescu in “Chemistry and Technology of Polyols for Polyurethanes”, Rapra Technology Limited, Shawbury 2005, p. 55 et seq. (chapt. 4: Oligo-polyols for Elastic Polyurethanes), p. 263 et seq. (chapt. 8: Polyester Polyols for Elastic Polyurethanes) and in particular to p. 321 et seq. (chapt. 13: Polyether Polyols for Rigid Polyurethane Foams) and p. 419 et seq. (chapt. 16: Polyester Polyols for Rigid Polyurethane Foams). It is also possible to obtain polyester and polyether polyols by glycolysis of suitable polymer recyclates. Suitable polyether-polycarbonate polyols and the production thereof are described for example in EP 2910585 A, [0024]-[0041]. Examples of polycarbonate polyols and production thereof may be found inter alia in EP 1359177 A. Production of suitable polyether ester polyols is described inter alia in WO 2010/043624 A and in EP 1 923 417 A.

The isocyanate-reactive component A) may further contain low molecular weight isocyanate-reactive compounds, in particular di- or trifunctional amines and alcohols, particularly preferably diols and/or triols having molar masses Mn of less than 400 g/mol, preferably of 60 to 300 g/mol, for example triethanolamine, diethylene glycol, ethylene glycol, glycerol. Polyol compounds falling under the definition of medium-chain polyol compounds are excluded from the group of low molecular weight isocyanate-reactive compounds. Provided such low molecular weight isocyanate-reactive compounds are used for producing the rigid polyurethane foams, for example as chain extenders and/or crosslinking agents, these are advantageously employed in an amount of up to 5% by weight based on the total weight of the component A).

In addition to the abovedescribed polyols and isocyanate-reactive compounds the component A) may contain further isocyanate-reactive compounds, in particular polyamines, polyamino alcohols and polythiols. It will be appreciated that the described isocyanate-reactive components also comprise compounds having mixed functionalities.

A preferred isocyanate-reactive component A) for the foams produced with this process contains 65% to 100% by weight, in particular 80% to 100% by weight, of the base polyol component selected from the group consisting of polyester polyol, polyether polyol, polyether ester polyol, polycarbonate polyol and/or polyether-polycarbonate polyol in a hydroxyl number range between 100 to 300 mg KOH/g and having functionalities of ≥1.2 to ≤3.5, 0% to 25% by weight, in particular 5% to 15% by weight of long-chain polyether polyols having a functionality of ≥1.2 to ≤3.5 and a hydroxyl number between 10 and 100 mg KOH/g, and 0% to 10% by weight, in particular 0% to 5% by weight, of low molecular weight isocyanate-reactive compounds having a molar mass Mₙ of less than 400 g/mol and 0% to 10% by weight, in particular 0% to 6% by weight, of medium-chain polyether polyols having functionalities of ≥2 to ≤6 and hydroxyl number between 300 and 700 mg KOH/g. The reported amounts in percent by weight are in each case based on the total weight of the isocyanate-reactive component A), of the catalyst component D) and of the assistant and additive substances E).

In a further preferred embodiment the isocyanate-reactive component A) contains at least one polyester polyol having a functionality of functionalities of ≥1.2 to ≤3.5 and a hydroxyl number of number of 100 to 300 mg KOH/g and also an acid number of 0 to 5.0 mg KOH/g in an amount of 65-100% by weight based on the total weight of the isocyanate-reactive component A; and a polyether polyol having a functionality of ≥1.8 to ≤3.5 and a hydroxyl number of 10 to 100 mg KOH/g, preferably 20 to 50 mg KOH/g, in an amount of 0% to 15% by weight based on the total weight of the isocyanate-reactive component A), of the catalyst component D) and of the assistant and additive substances E).

The reaction mixture may contain assistant and additive substances E). These may be added in whole or in part to the isocyanate-reactive component A) or metered into the mixture of the components directly.

The assistant and additive substances E) preferably comprise emulsifiers. Compounds employable as suitable emulsifiers which also act as foam stabilizers include all commercially available silicone oligomers modified by polyether side chains which are also employed for producing conventional polyurethane foams. When emulsifiers are employed they are employed in amounts of preferably up to 8% by weight, particularly preferably 0.5% to 7% by weight, in each case based on the total weight of the isocyanate-reactive composition. Preferred emulsifiers are polyether polysiloxane copolymers. These are commercially available for example under the names B84504 and B8443 from Evonik, Niax L-5111 from Momentive Performance Materials, AK8830 from Maystar and Struksilon 8031 from Schill and Seilacher. Silicone-free stabilizers, such as for example LK 443 from Air Products, may also be employed.

The component E) further comprises all additives typically added to isocyanate-reactive compositions. Examples of such additives are cell regulators, thixotropic agents, plasticizers and colorants.

Flame retardants may in particular also be added to the isocyanate-reactive compositions to improve flame retardancy. Such flame retardants are known in principle to the person skilled in the art and are described, for example, in “Kunststoffhandbuch”, volume 7 “Polyurethane”, chapter 6.1. These include for example halogenated polyesters and polyols, brominated and chlorinated paraffins or phosphorus compounds, such as for example the esters of orthophosphoric acid and of metaphosphoric acid, which may likewise contain halogen. It is preferable to choose flame retardants that are liquid at room temperature. Examples include triethyl phosphate, diethylethane phosphonate, cresyldiphenyl phosphate, dimethylpropane phosphonate and tris(β-chloroisopropyl) phosphate. Flame retardants selected from the group consisting of tris(chloro-2-propyl) phosphate (TCPP) and triethyl phosphate (TEP) and mixtures thereof are particularly preferred. It is preferable to employ flame retardants in an amount of 1% to 30% by weight, particularly preferably 5% to 30% by weight, based on the total weight of the isocyanate-reactive composition isocyanate-reactive component. It may also be advantageous to combine different flame retardants with one another to achieve particular profiles of properties (viscosity, brittleness, flammability, halogen content etc.).

The process according to the invention makes it possible for solid additives, for example solid flame retardants or fillers, and/or additives which increase the viscosity of the reaction mixture upon addition to be used or used in greater amounts than is customary while nevertheless producing homogeneous foam panels having good surface qualities since confluence of individual strands of the reaction mixture is not necessary.

The component B) is a polyisocyanate, i.e. an isocyanate having an NCO functionality of ≥2. Examples of such suitable polyisocyanates include 1,4-butylene diisocyanate, 1,5-pentane diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs, 1,3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1 to C6-alkyl groups.

Preferably employed as the isocyanate component B) are mixtures of the isomers of diphenylmethane diisocyanate (“monomeric MDI”, “mMDI” for short) and oligomers thereof (“oligomeric MDI”). Mixtures of monomeric MDI and oligomeric MDI are generally described as “polymeric MDI” (pMDI). The oligomers of MDI are higher-nuclear polyphenylpolymethylene polyisocyanates, i.e. mixtures of the higher-nuclear homologs of diphenylmethylene isocyanate which have an NCO functionality f>2 and may be described by the following empirical formula: C₁₅H₁₀N₂O₂[C₈H₅NO]ₙ, wherein n=integer>0, preferably n=1, 2, 3 and 4. Higher-nuclear homologs C₁₅H₁₀N₂O₂ [C₈H₅NO]ₘ, m=integer≥4) may likewise be present in the mixture of organic polyisocyanates a). Likewise preferred as the isocyanate component B) are mixtures of mMDI and/or pMDI comprising at most up to 20% by weight, more preferably at most 10% by weight, of further aliphatic, cycloaliphatic and especially aromatic polyisocyanates known for the production of polyurethanes, very particularly TDI.

The polyisocyanate component B) moreover has the feature that it preferably has a functionality of at least 2, in particular at least 2.2, particularly preferably at least 2.4 and very particularly preferably at least 2.7.

For use as the polyisocyanate component polymeric MDI types are particularly preferred over monomeric isocyanates in rigid foam. However, since the viscosity of the isocyanate component increases with increasing functionality conventional application of PUR and/or PUR/PIR reaction systems using rake applicators has limits since the individual strands of the high-viscosity reaction system do not undergo sufficient confluence after application. The process according to the invention makes it possible to employ isocyanates having higher viscosities than the customary range up to 1000 mPas, for example a polymeric MDI having a viscosity of 2500 mPas at 25° C. Despite the higher viscosity of the reaction mixture resulting therefrom the process according to the invention produces homogeneous foam panels having good surface qualities since confluence of individual strands of the reaction mixture is not necessary. Application using the curtain coating apparatus according to the invention also makes it possible to process reaction systems comprising high viscosity isocyanate types since—contrary to conventional application using a rake applicator for example—there are no individual strands. The need for confluence therefore does not apply.

The NCO content of the isocyanate component B) is preferably from ≥29.0% by weight to ≤33.0% by weight and preferably has a viscosity at 25° C. of ≥80 mPas to ≤2900 mPas, particularly preferably of ≥95 mPas to ≤850 mPas at 25° C.

The NCO value (also known as NCO content, isocyanate content) is determined according to EN ISO 11909:2007. Unless otherwise stated values at 25° C. are concerned.

Reported viscosities are dynamic viscosities determined according to DIN EN ISO 3219:1994-10 “Plastics—Polymers/Resins in the liquid State or as Emulsions or Dispersions”.

In addition to the abovementioned polyisocyanates, it is also possible to use proportions of modified diisocyanates of uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

Also employable instead of or in addition to the abovementioned polyisocyanates as the organic isocyanate component B) are suitable NCO prepolymers. The prepolymers are producible by reaction of one or more polyisocyanates with one or more polyols according to the polyols described under the components A). The isocyanate may be a prepolymer obtainable by reaction of an isocyanate having an NCO functionality of ≥2 and polyols having a molar mass Mₙ of ≥62 g/mol to ≤8000 g/mol and OH functionalities of ≥1.5 to ≤6.

Isocyanate-reactive component A) and isocyanate component B) are mixed to produce a reaction mixture which can react to afford PUR or PUR/PIR foams. This reaction mixture may be produced directly in a mixing head.

The isocyanate ratio (also known as index or isocyanate index) is to be understood as meaning the quotient of the actually employed amount of substance [mol] of isocyanate groups and the actually employed amount of substance [mol] of isocyanate-reactive groups, multiplied by 100:

Index=(mols of isocyanate groups/mols of isocyanate-reactive groups)*100.

In the reaction mixture the number of NCO groups in the isocyanate and the number of isocyanate-reactive groups may result in an index of 90 to 600, preferably between 115 and 400. This index is preferably in a range of >180 to <450 (in this range a high proportion of polyisocyanurates (PIR) is present and the rigid foam is described as PIR foam or PUR/PIR foam). Another preferred range for the isocyanate index is the range from >90 to <140 (in this range the rigid foam is described as a polyurethane foam (PUR foam)).

The reaction mixture optionally further contains catalyst components D) which are suitable for catalyzing the blowing reaction, the urethane reaction and/or the isocyanurate reaction (trimerization). The catalyst components may be metered into the reaction mixture or else initially charged in the isocyanate-reactive component A) in whole or in part.

Suitable therefor are in particular one or more catalytically active compounds selected from the following groups:

D1) aminic catalysts, for example amidines, such as 2,3-dimethyl-3,4,5,6-tetrahydropyrimidine, tertiary amines, such as triethylamine, tributylamine, dimethylcyclohexylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine-1,6, pentamethyldiethylenetriamine, bis(2-dimethylaminoethyl ether, bis(dimethylaminopropyl)urea, dimethylpiperazine, 1,2-dimethylimidazole, N,N′,N″-tris(dimethylaminopropyl)hexahydrotriazine, bis[2-(N,N-dimethylamino)ethyl] ether, 1-azabicyclo-(3,3,0)-octane and 1,4-diazabicyclo-(2,2,2)-octane, and alkanolamine compounds, such as triethanolamine, triisopropanolamine, N-methyl- and N-ethyldiethanolamine, N,N-dimethylaminoethoxy ethanol, N,N,N′-trimethylaminoethylethanolamine and dimethylethanolamine. Particularly suitable compounds are selected from the group comprising tertiary amines, such as triethylamine, tributylamine, dimethylcyclohexylamine, dimethylbenzylamine, N,N,N′,N′-tetramethylethylenediamine, pentamethyldiethylenetriamine, bis(2-dimethylaminoethyl) ether, dimethylpiperazine, 1,2-dimethylimidazole and alkanolamine compounds, such as tris(dimethylaminomethyl)phenol, triethanolamine, triisopropanolamine, N-methyl- and N-ethyldiethanolamine, N,N-dimethylaminoethoxyethanol, N,N,N′-trimethylaminoethylethanolamine and dimethylethanolamine

In a particularly preferred embodiment the catalyst component employs one or more aminic compounds having the structure:

(CH₃)₂N—CH₂—CH₂—X—CH₂—CH₂—Y

wherein Y═NR₂ or OH, preferably Y═N(CH₃)₂ or OH, particularly preferably Y═N(CH₃)₂ and wherein X═NR or O, preferably X═N—CH₃ or O, particularly preferably X═N—CH₃. Every R may be chosen independently of every other R and represents an organic radical
of any desired structure having at least one carbon atom. R is preferably an alkyl group having 1 to 12 carbon atoms, in particular C1- to C6-alkyl, particularly preferably methyl and ethyl, in particular methyl.
D2) carboxylates of alkali metals or alkaline earth metals, in particular sodium acetate, sodium octoate, potassium acetate, potassium octoate, and tin carboxylates, for example tin(II) acetate, tin(II) octoate, tin(II) ethylhexoate, tin(II) laurate, dibutyltin diacetate, dibutyltin dilaurate, dibutyltin maleate and dioctyltin acetate, and ammonium carboxylates. Sodium, potassium and ammonium carboxylates are especially preferred. Preferred carboxylates are formates, ethylhexanoates (=octoates), propionates and acetates.

The catalyst preferably contains one or more catalysts selected from the group consisting of potassium acetate, potassium octoate, pentamethyldiethylenetriamine, N,N′,N″-tris(dimethylaminopropyl)hexahydrotriazine, tris(dimethylaminomethyl)phenol, bis[2-(N,N-dimethylamino)ethyl] ether and N,N-dimethylcyclohexylamine, particularly preferably from pentamethyldiethylenetriamine, N,N′,N″-tris(dimethylaminopropyl)hexahydrotriazine and N,N-dimethylcyclohexylamine, particularly preferably from pentamethyldiethylenetriamine, N,N′,N″-tris(dimethylaminopropyl)hexahydrotriazine and N,N-dimethylcyclohexylamine in combination with potassium acetate, potassium octoate or potassium formate or sodium formate.

In a preferred embodiment the catalysts required for producing the rigid foam, in particular aminic catalysts (D1) in combination with salts used as trimerization catalysts, are employed in an amount such that for example in continuously running plants elements having flexible outerlayers can be produced at a rate of up to 80 m/min depending on element thickness.

The reactivity of the reaction mixture is generally adapted to the conditions using catalyst (or by means of other reactivity-enhancing components, for example amino polyethers). Production of thin panels thus requires a reaction mixture having a higher reactivity than production of thicker panels. Cream time and fiber time are respectively typical parameters for the time taken for the reaction mixture to begin to react and for the point at which a sufficiently stable polymer network has been formed. Typical cream times (characterized by commencement of foaming of the reaction mixture upon visual inspection) for processing using conventional techniques are in the range from 2 seconds to 50 seconds.

Application using a curtain coating apparatus according to the invention now also allows advantageous processing of reaction mixtures having high or relatively high reactivities, i.e. cream times of <5 s, in particular <2 s, very particularly <1 s, and fiber times of <25 s, in particular <20 s and very particularly <14 s. The use of the curtain coating apparatus according to the invention may be advantageous in particular for the production of thin panels since little material is available for confluence here.

It is preferable to use a combination of catalyst components D1 and D2 in the reaction mixture. In this case the molar ratio should be chosen such that the D2/D1 ratio is between 0.1 and 80, in particular between 2 and 20. Short fiber times may be achieved for example with more than 0.9% by weight of potassium 2-ethylhexanoate based on all components of the reaction mixture.

The reaction mixture further contains sufficient blowing agent C) as is required for achieving a dimensionally stable foam matrix and the desired apparent density. This is generally 0.5-30 parts by weight of blowing agent based on 100 parts by weight of the component A. Preferably employed blowing agents are physical blowing agents selected from at least one member of the group consisting of hydrocarbons, halogenated ethers and perfluorinated and partially fluorinated hydrocarbons having 1 to 8 carbon atoms. In the context of the present invention “physical blowing agents” are to be understood as meaning compounds which on account of their physical properties are volatile and unreactive toward the isocyanate component. The physical blowing agents to be used according to the invention are preferably selected from hydrocarbons (for example n-pentane, isopentane, cyclopentane, butane, isobutane, propane), ethers (for example methylal), halogenated ethers, (per)fluorinated hydrocarbons having 1 to 8 carbon atoms (for example perfluorohexane) and mixtures thereof with one another. Also preferred is the use of (hydro)fluorinated olefins, for example HFO 1233zd(E) (trans-1-chloro-3,3,3-trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4-(trifluoromethyl)pent-2-ene) and the use of combinations of these blowing agents. In particularly preferred embodiments the blowing agent C) employed is a pentane isomer or a mixture of different pentane isomers. It is exceptionally preferable to employ a mixture of cyclopentane and isopentane as the blowing agent C). Further examples of preferably employed hydrofluorocarbons are for example HFC 245fa (1,1,1,3,3-pentafluoropropane), HFC 365mfc (1,1,1,3,3-pentafluorobutane), HFC 134a or mixtures thereof. Different blowing agent classes may also be combined.

Also especially preferred is the use of (hydro)fluorinated olefins, for example HFO 1233zd(E) (trans-1-chloro-3,3,3-trifluoro-1-propene) or HFO 1336mzz(Z) (cis-1, 1,1,4,4,4-hexafluoro-2-butene) or additives such as FA 188 from 3M (1,1,1,2,3,4,5,5,5-nonafluoro-4(or 2)-(trifluoromethyl)pent-2-ene and/or 1,1,1,3,4,4,5,5,5-nonafluoro-4(or 2)-(trifluoromethyl)pent-2-ene), alone or in combination with other blowing agents. These have the advantage of having a particularly low ozone depletion potential (ODP) and a particularly low greenhouse warming potential (GWP). The process according to the invention allows advantageous employment of (hydro)fluorinated olefins as blowing agents for composite systems since it allows production of composite elements having improved surface structures and improved adhesion to the outerlayer compared to composite elements produced with other application techniques.

Chemical blowing agents (also referred to as “co-blowing agents”) may be employed instead of or in addition to the abovementioned physical blowing agents. These are particularly preferably water and/or formic acid. The chemical blowing agents are preferably employed together with physical blowing agents. It is preferable when the co-blowing agents are employed in an amount up to 6% by weight, particularly preferably 0.5% to 4% by weight, for the composite elements based on the total amount of compounds having isocyanate-reactive hydrogen atoms in the component A.

Preferably employed for composite elements is a mixture of 0 to 6.0% by weight of co-blowing agent and 1.0% to 30.0% by weight of blowing agent in each case based on 100% by weight of the component A. However, the quantity ratio of co-blowing agent to blowing agent may also be from 1:7 to 1:35 according to requirements.

The process according to the invention is also employable with particular advantage for application of a reaction mixture which starts to foam even in the application apparatus (“froth”), for example as a result of a low boiling point and/or poor solubility of the blowing agent, high temperatures in the nozzle and/or as a result of reaction already commencing in the nozzle. Application of froth with a standard strand application apparatus, for example using a rake applicator, results in poor distribution which can in turn have a negative effect on the quality of the end product. The process according to the invention results in immediate wetting of the outerlayer over its entire width during application, thus resulting in more homogeneous products, particularly when applying a foaming mixture.

As described above the process particularly also makes it possible to add solid components and/or components having high viscosities to the reaction mixture instead of or in addition to the generally liquid (or gaseous) components, for example solid flame retardants such as expanding graphite, melamine, ammonium polyphosphate, red phosphorus or inorganic oxides and hydroxides. These may either be present in the isocyanate-reactive component A) as additives or be added separately, generally as a dispersion in other assistants, for example liquid flame retardants.

Since the addition of solids increases the viscosity of the reaction mixture this results—as described hereinabove—in limitations for processing using conventional application techniques, for example using a rake applicator.

The maximum processable viscosity of a mixture of the components A), C), D) and E) is typically about 5000 mPas (25° C.). This limitation for the use of such high-viscosity, optionally solids-containing mixtures does not apply to processing using the curtain coating apparatus according to the invention since the reaction mixture is not applied in the form of individual strands. As a result, even polyol formulations or isocyanates having viscosities up to 20 000 mPas at 25° C. are processable in advantageous fashion.

The plant for applying a foaming reaction mixture employed in the process according to the invention comprises at least one curtain coating apparatus, wherein the curtain coating apparatus comprises:
a feed connection for introducing the reaction mixture of the components A), B) and C) and optionally D) and E),
at least one discharge slot extending in a transverse direction (Q) for discharging the reaction mixture,
two opposing slot plates,
   wherein a slot space extends between the slot plates in a vertical direction (H) above the discharge slot wherein formed between the slot plates is a feed channel connected to the feed connection which closes the slot space above the discharge slot in the vertical direction (H), wherein the feed channel has a channel cross section whose principal dimension is greater than the width (B) of the slot space so that the reaction mixture is introduceable into the slot space distributed over the length of the feed channel

The curtain coating apparatus used in the process according to the invention and the plant comprising this curtain coating apparatus is described in its different embodiments in the as yet unpublished patent application having international application number PCT/EP2016/068574.

The at least one curtain coating apparatus employed in the plant according to the invention has the following features: Said apparatus contains a guiding means for the reaction mixture between the feed connection and the discharge slot which is formed in such a way that each unit volume of the reaction mixture can pass through the curtain coating apparatus between the feed connection and the discharge slot in the same passthrough time. In other words each stream filament of the reaction mixture has the same residence time between the feed connection and the discharge slot. This is achieved with a feed channel which connects to the feed connection inside the curtain coating apparatus wherein the feed channel is formed between the slot plates.

Formation “between” the slot plates here describes a configuration of the feed channel which is formed either in a first slot plate, in an opposing second slot plate or in both slot plates by a corresponding geometry. The cross section of the feed channel need not be round, but rather may also be semicircular, trapezoidal, elliptical, rectangular or the like. The feed channel may in particular also be formed when an appropriate cutout, for example having a semicircular or rectangular channel cross section, is formed in just one of the two slot plates. The opposing slot plate may have a flat face and laterally delimit the feed channel or the opposite slot plate mirrors the first with the same recessed geometry or a modified recessed geometry to form the channel cross section symmetrically over the slot space. In any case the formation of the feed channel “between” the slot plates in the context of the present use of the word describes any possible cutout shape and other geometries in the surface of the slot plate.

It will be appreciated that the slot space may be incorporated into both slot plates or just on one side into one of the slot plates. It is in particular also possible to introduce the feed channel with the feed connection and the slot space into just one slot plate since the opposing slot plate may then particularly advantageously be completely flat.

The principal dimension of the channel cross section is wider than the width of the slot space so that the reaction mixture can get to the end of the feed channel, the channel cross section of the feed channel being configured such that a defined pressure drop of the flow mixture is produced with increasing distance from the feed channel. The reaction mixture exits the feed channel uniformly distributed over its entire length and arrives in the manner of a flow curtain in the slot space which follows below the feed channel. This produces a linear outflow of the reaction mixture out of the feed channel so that the reaction mixture is introduceable into the slot space distributed over substantially the entire length of the feed channel. The length of the feed channel extends in the transverse direction over a length which also corresponds to the length of the discharge slot. In particular the ends of the discharge slot terminate with the ends of the feed channel

In an advantageous development of the curtain coating apparatus employed in the process according to the invention the channel cross section decreases with increasing distance from the feed connection. The channel cross section is advantageously largest at the connection point to the feed connection and progressively decreases with increasing distance from the feed connection. The feed channel may extend away from the feed connection in the transverse direction to an equal extent on both sides and the feed channel has its largest cross section at the connection point to the feed connection. The respective outer ends of the feed duct may have a cross section small enough to terminate with the width of the slot space. This prevents an elevated amount of reaction mixture from being able to be discharged from the discharge slot at the ends of the feed channel

The width of the slot space may be the same as the width of the discharge slot or the width of the discharge slot is at least slightly smaller than the width of the slot space in particular to maintain a residual pressure difference in the reaction mixture before and after passage through the discharge slot, thus resulting in further uniformization of reaction mixture discharge.

In a further embodiment the width of the discharge slot can increase from the width of the slot space in the direction of the discharge opening in order to reduce the discharge velocity or to compensate for a volume increase during commencement of foaming.

It is also advantageous when the slot space has a width which remains constant over substantially the entire areal extent of the slot space between the slot plates, with small local deviations in width from the otherwise uniform width being possible however, for example at points where screw elements pass through the slot space. It is additionally advantageous when the feed channel has a curvature so that the height of the slot space above the discharge slot decreases with increasing distance from the feed connection. The height of the slot space between the discharge slot and the feed channel thus decreases with increasing distance from the feed connection so that the flow resistance and the passthrough time decrease between the feed channel and the discharge slot. However, the flow resistance simultaneously increases over a longer path through the feed channel so that the total pressure drop remains constant. The higher flow rate in the feed channel than in the slot altogether has the result that the reaction mixture experiences the same passthrough time between the feed connection and the discharge slot over the entire length of each flow path.

The changing channel cross section of the feed channel and the curvature for adjusting the height of the slot space above the discharge slot are matched to one another so as to achieve the identical passthrough time of the reaction mixture over the entire length of the discharge slot. It is thus also conceivable for the curvature of the feed channel to increase with increasing distance from the feed connection. The feed channel may for example have an approximately parabolic curvature, wherein the curvature increases with increasing distance from the feed connection. This gives the feed channel approximately the shape of a clothes hanger so that in particular the edge-side delimitation of the areal slot space deviates from a triangular shape. By contrast, the slot space extends between the discharge slot and the feed channel with an altogether constant width and the constant width over the entire areal extent of the slot space additionally results in a homogenization of the flow rate. This can achieve the particular feature that the reaction mixture has the same discharge velocity over the entire length of the discharge slot in the transverse direction.

The matching of the volume ratios and geometries of the components of the curtain coating apparatus involved in guiding the reaction mixture is carried out for example with computer assistance, preferably using a computational fluid dynamics (CFD) calculation. The length of the feed connection and/or the length of the feed channel and/or the height of the slot space in the vertical direction above the discharge slot are determined such that the volume elements of the reaction mixture can experience an identical passthrough time over the entire length of the discharge slot, that each volume element has an identical velocity value over the length of the discharge slot and that the passthrough time of the reaction mixture through the curtain coating apparatus is less than the reaction time. This means that the passthrough time of the reaction mixture from the mixing head which is connected upstream of the feed connection to the discharge slot is sufficiently short to ensure that the reaction mixture does not begin to foam before discharging from the discharge slot.

The plant employed in the process according to the invention for applying the foaming reaction mixture comprising isocyanate-reactive component A), polyisocyanate component B) and blowing agent component C) comprises at least one and preferably a plurality of the curtain coating apparatuses described herein, wherein the discharge slots of the plurality of curtain coating apparatuses extend in a common transverse direction or arcuately over the outerlayer.

The at least one curtain coating apparatus [(100), the reference numerals relate to the exemplary embodiments shown in the figures for elucidation] employed comprises a feed connection (12) for introducing the reaction mixture (10), at least one discharge slot (13) extending in a transverse direction (Q) for discharging the reaction mixture (10) and two opposing slot plates (14), wherein a slot space (15) extends between the slot plates (14) in a vertical direction (H) above the discharge slot (13), and is characterized in that formed between the slot plates (14) is a feed channel (16) connected to the feed connection (12) which closes the slot space (15) above the discharge slot (13) in the vertical direction (H), wherein the feed channel (16) has a channel cross section (17) whose principal dimension is greater than the width (B) of the slot space (15) so that the reaction mixture is introduceable into the slot space (15) distributed over the length of the feed channel (16).

Preference is further given to the following embodiments of the curtain coating apparatuses:

2) the curtain coating apparatus (100) is characterized in that the channel cross section (17) decreases with increasing distance from the feed connection (12) and/or
3) the curtain coating apparatus (100) is characterized in that the slot space (15) has a width (B) which remains constant over substantially the entire areal extent of the slot space (15) between the slot plates (14) and/or
4) the curtain coating apparatus (100) is characterized in that the feed channel (16) has a curvature so that the slot space (15) has a decreasing height above the discharge slot (13) with increasing distance from the feed connection (12). In this case it is possible that
5) the curvature of the feed channel (16) increases with increasing distance from the feed connection (12).

The curtain coating apparatus having the features according to 2), 3), 4) and/or 5) may preferably be further characterized in that

6) the changing channel cross section (17) of the feed channel (16) and/or the curvature of the feed channel (16) and/or the formation of the slot space (15) are determined such that the discharge velocity of each volume element of the reaction mixture (10) has an identical velocity value over the length of the discharge slot (13) and/or that
7) the changing channel cross section (17) of the feed channel (16) and/or the curvature of the feed channel (16) and/or the formation of the slot space (15) are determined such that each volume element of the reaction mixture (10) based on the length of the discharge slot (13) has an identical passthrough time from the feed connection (12) until discharge from the discharge slot (13) and/or
8) that the length of the feed connection (12) and/or the length of the feed channel (16) and/or the height of the slot space (15) in the vertical direction (H) above the discharge slot (13) are determined such that the passthrough time of the reaction mixture (10) is less than the reaction time and/or
9) that adjustment means by which the width of the discharge slot (13) is adjustable are provided, wherein a plurality of adjustment means are provided distributed over the length of the discharge slot (13).

In order to counteract a shortening of the discharge slot due to blockage of the slot from the sides it may be advantageous to configure each individual curtain coating apparatus used in the plant or else the entire plant per se such that its distance to the lower outerlayer may be varied during the process according to the invention, i.e. during application of the reaction mixture.

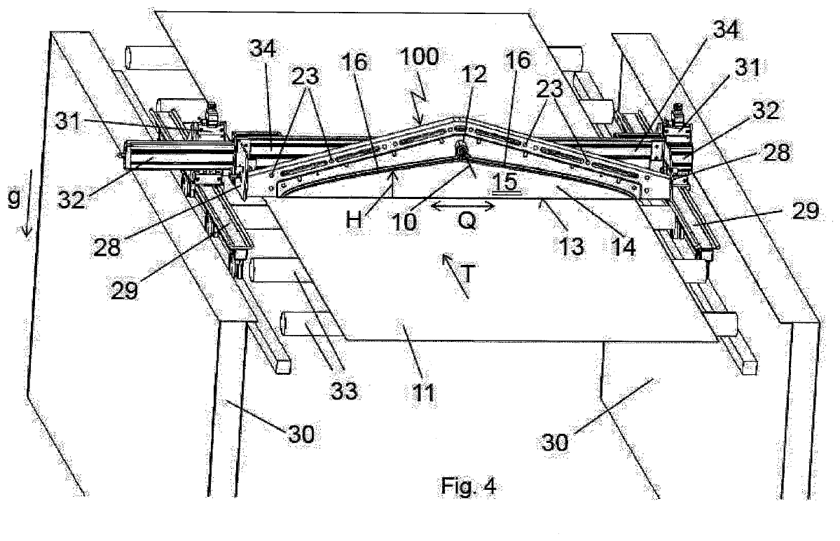

At commencement of production the position of the curtain coating apparatus over the outerlayer is adjusted such that the reaction mixture is applied to the lower outerlayer in the desired manner and width. It may be advantageous when the total length of the discharge slot of the curtain coating apparatus is greater than the width of the outerlayer in order to compensate for any constriction of the discharge film at the sides. A lateral blocking of the discharge slot during operation may then moreover be compensated by a reduction in the vertical distance, i.e. the height of the curtain coating apparatus/the plant comprising the at least one curtain coating apparatus is repositioned during operation using a suitable adjustment means such that the outerlayer is wetted over a width that remains constant over time. This embodiment makes it possible to increase the uptime of the plant in the process according to the invention. One exemplary embodiment is shown in FIG. 4. One advantageous development of this embodiment of the curtain coating apparatus employed in the process according to the invention which allows adjustment of the distance of the discharge slot to the outerlayer surface comprises measuring the length of the current discharge film during production by laser measurement for example and thus controlling the distance position using motors for example

It may also be advantageous during use in the process to provide the curtain coating apparatus with one or more inserts, for example made of plastic, which protect the inside of the slot plates from contamination. The inserts may preferably be provided in the form of dimensionally stable, separate plastic parts whose geometry is adapted to the internal surface geometry of the slot plate, for example the plastic inserts may be produced as injection molded parts or as thermoformed parts. However, it is also possible to provide the plastic insert(s) in the form of a flexible film which adapts to the geometry of the surface. In addition to being made of plastic the inserts may also be produced from metal or other suitable materials. Depending on the choice of material the inserts used may be reusable parts or single-use parts. In any case the use of inserts has the advantage that time-consuming cleaning of the curtain coating apparatus is avoided and the apparatus is sooner available for reuse. In a particularly suitable embodiment of the process the inserts are inserted into the curtain coating apparatus prior to commencement of production and removed again after termination. In an advantageous development of the curtain coating apparatus employed in the process according to the invention said apparatus is hinged so that the insertion and removal of the inserts may preferably be carried out with the open curtain coating apparatus in the production mode or in a park position.

The use of separate inserts has the following advantages: Depending on the choice of material and/or surface characteristics of the inserts it is possible not only to facilitate and speed up cleaning of the curtain coating apparatus/the plant used in the process according to the invention but also to increase the uptime of the plant on account of the reduced adhesion of the reaction mixture to the surface of the inserts which are advantageously contacted mainly by the reaction mixture and/or on account of slower blockage of the slot space.

In the plant the at least one curtain coating apparatus may be tiltable around an axis, for example parallel to the outerlayer and perpendicular to the conveying direction of the outerlayer, so that the apparatus need not apply the reaction mixture to the outerlayer precisely vertically but for example also in leading or trailing fashion. Tilting makes it possible to adjust the angle between the discharge film and the outerlayer such that optimal flow conditions for the reaction mixture in the impact region are achieved.

In the plant the at least one curtain coating apparatus may also be arranged such that it is rotatable around an axis perpendicular to the lower outerlayer. Depending on the choice of the angle of the curtain coating apparatus and thus of the angle between the discharge slot and the conveying direction of the outerlayer the application width of the reaction mixture is adapted to the outerlayer width and/or the guiding of the rising foam formed from the reaction mixture is favorably affected upon reaching the upper outerlayer.

The plant used in the process according to the invention for applying the foaming reaction mixture in particular comprises an arrangement of a plurality of curtain coating apparatuses having the abovementioned features.

When a plurality of curtain coating apparatuses are used these are in particular arranged side-by-side such that the total length of the discharge slot in the common transverse direction is adapted to the outerlayer width. This makes it possible to make the curtain coating apparatus smaller and thus to reduce the passthrough time and the individual slot spaces of the plurality of slot spaces which are upwardly delimited by respective feed channels form individual curtain coating apparatuses, where the length of the entire discharge slot need not, however, correspond to the outerlayer width. Each of the individual curtain coating apparatuses may have a separate feed connection fed by separate mixing heads in each case but it is advantageously also possible to feed the plurality of feed connections with one mixing head. A hose system or a pipe distributor system may be provided for supplying the reaction mixture to the feed connections.

In one embodiment of the plant used in the process according to the invention the slot plates of the plurality of curtain coating apparatuses may together form one piece on one or both sides of the slot space. In the case of a one-piece construction the various feed channels may be fed via a central feed connection and a downstream, for example star-shaped, distributor system. The slot plates may be subjected to shaping processes such that a plurality of feed channels and slot spaces adjoining below the feed channels are formed. It is in particular conceivable to provide each feed channel with its own feed connection.

The ends of the feed channels of the plurality of curtain coating apparatuses that are remote from the feed connections may advantageously also be adjacent to one another. Provided the passthrough time and the discharge velocity of the reaction mixture from the discharge slot of the individual curtain coating apparatuses are identical over the particular slot length in the transverse direction it can be expected that the passthrough time and the discharge velocity of the reaction mixture are identical along the entire discharge slot. This ensures that a constant uniform application of the reaction mixture is also altogether achieved over the entire outerlayer width. The total length of the discharge slot is virtually equal to the outerlayer width though it may be provided to choose an application width of the reaction mixture that is slightly smaller than the outerlayer width. For example the outerlayer may have a width of 120 cm and the total length of the discharge slot is for example 115 cm and extends over the width of the outerlayer. The smaller application width of the reaction mixture in relation to the width of the outerlayer is preferably chosen to avoid unintended discharge outside the outerlayer. Since the reaction mixture also undergoes foaming over the width of the outerlayer and thus expands the edge region of the outerlayer is therefore also reached and covered.

When a plurality of curtain coating apparatuses are arranged side-by-side these are for example mounted in an adjustable carrier, wherein as described above the plurality of curtain coating apparatuses may also form one structural unit, for example having common slot plates.

When using a plurality of curtain coating apparatuses these are preferably arranged such that the discharge slots of the individual curtain coating apparatuses form a common, continuous and straight or arcuate discharge slot. In an extended embodiment these may also be rotated relative to one another such that the individual discharge slots each enclose an angle to one another and altogether form a polygon or an arc. This allows even better adaptability to the outerlayer width and/or guiding of the rising foam upon reaching the upper outerlayer. When using a plurality of curtain coating apparatuses it is likewise possible for these to be arranged one behind the other (optionally offset) as seen in the movement direction of the outerlayer so that the reaction mixture discharged from the discharge slot of one curtain coating apparatus at least partially contacts the reaction mixture discharged from the discharge openings of the other curtain coating apparatuses.

In a preferred embodiment the plant for use according to the invention comprises two or more of the described curtain coating apparatuses, wherein the discharge slots of the curtain coating apparatuses extend in a common transverse direction (Q) or arcuately over the outerlayer. The plant is thus particularly suitable for application of a foaming reaction mixture onto at least a partial width of an outerlayer and in particular for producing a composite element. The slot plates of the plurality of curtain coating apparatuses may together form one piece on both sides of the slot space. When using a plurality of curtain coating apparatuses the ends of the feed channels of the plurality of curtain coating apparatuses that are remote from the feed connections may be adjacent to one another.

Continuous production of PUR and PUR/PIR foam panels can in particular suffer from the problem that the application apparatus employed becomes blocked during application, in particular in the regions of the employed apparatus experiencing a weaker flow of reaction mixture.

In order to counter this problem the process according to the invention may provide for providing the reaction mixture with a gas loading and in particular with an air loading. An air loading avoids blockage of the slot space in particular in the regions of the slot space experiencing a weaker flow of reaction mixture. To this end the plant comprises a gas loading means with which the reaction mixture may be loaded with a gas. The gas loading means is configured such that gas loading may be effected with air, with nitrogen, with carbon dioxide or with noble gas, in particular argon or helium. This use of dried air or of nitrogen in particular advantageously ensures that the thin slot space between the slot plates does not become blocked with prematurely foaming reaction mixture.

The process according to the invention thus makes it possible to realize one or more of the following advantages compared to conventional application techniques: uniform application over the entire belt width; rapid reaction systems having short cream times may be employed, thus allowing faster belt speeds. Likewise advantageously employable are high viscosity reaction systems and/or reaction systems which foam in the nozzle. The finished PUR or PUR/PIR rigid foams show little in the way of overlap/bubbles/voids and/or show a good surface quality, a better adhesion to the outerlayer and/or are very homogeneous and exhibit for example a uniform cell orientation, homogeneous density distribution and good mechanical properties, for example compressive strength.

The figures show exemplary embodiments of the curtain coating apparatus employable in the process according to the invention and a plant containing this curtain coating apparatus.

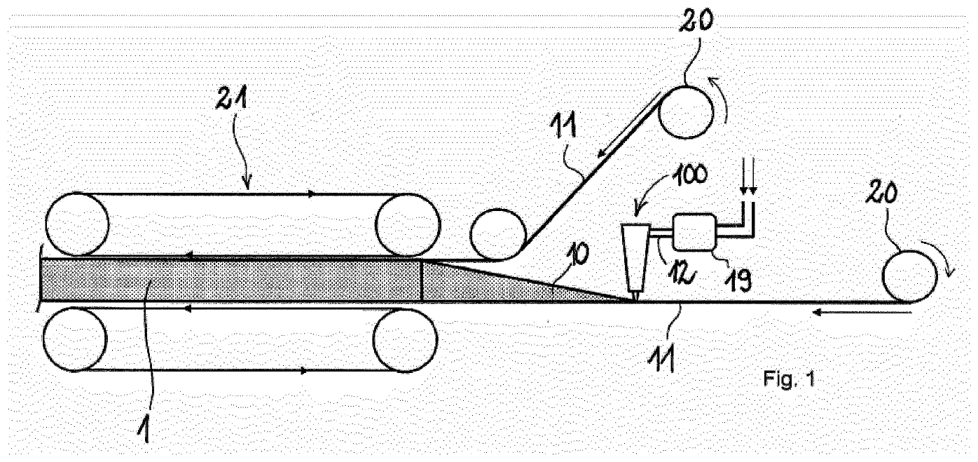

FIG. 1 shows a general view of the plant comprising a curtain coating apparatus 100 and the feeding of outerlayers and also a double belt conveying plant 21.

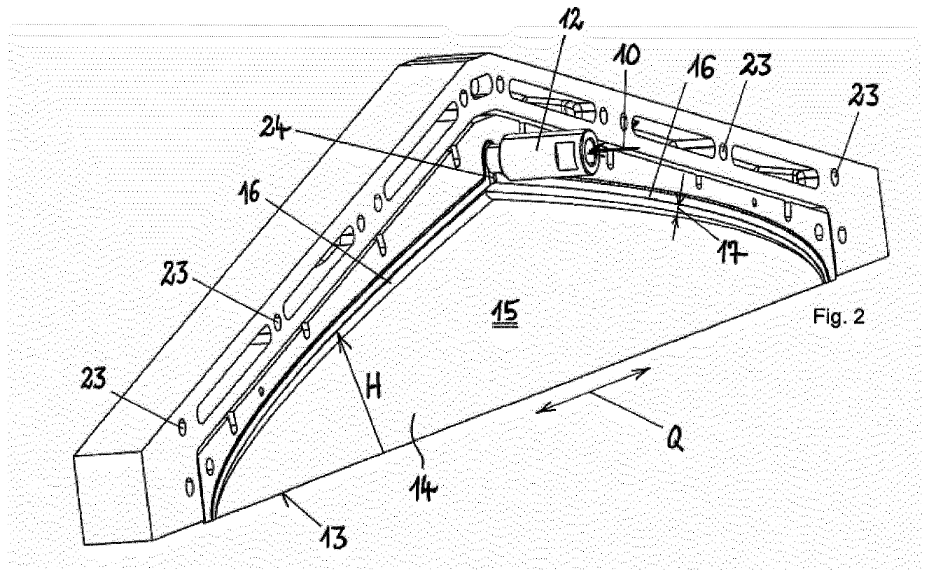

FIG. 2 shows a perspective view of a slot plate 14 from the side which areally delimits the slot space,

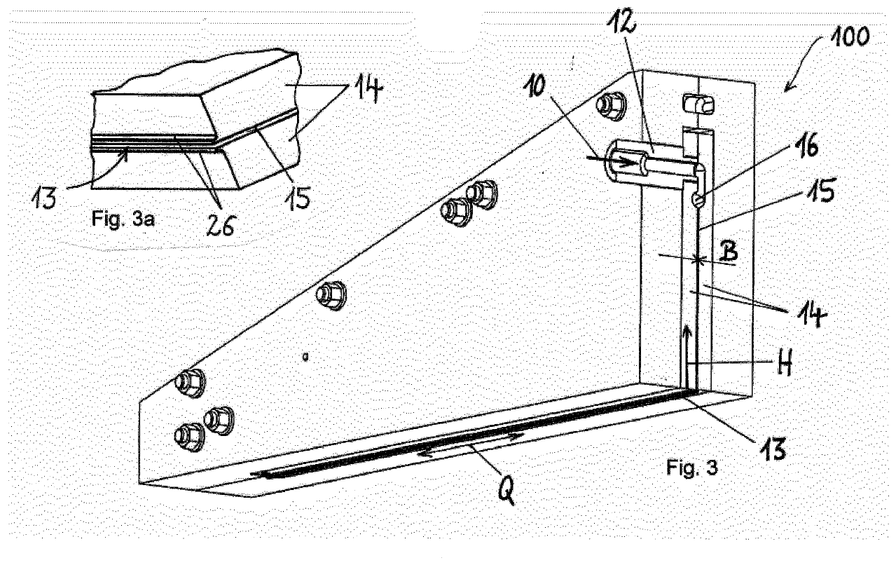

FIG. 3 shows a cross sectional view of the curtain coating apparatus comprising two superposed slot plates to form the slot space between the slot plates,

FIG. 3a shows a developed embodiment of the discharge slot having slot lips formed thereupon

FIG. 4 shows a perspective view of the plant employed in the process according to the invention comprising an installed curtain coating apparatus for applying a foaming reaction mixture

FIG. 1 shows a schematic view of a plant for operating a process used for producing composite elements 1. The plant comprises a double belt conveying plant 21 which receives two outerlayers 11. A lower outerlayer 11 is unrolled from an outerlayer roll 20 and an upper outerlayer 11 is likewise unrolled from a further outerlayer roll 20. The two outerlayers 11 are introduced into the conveying plant 21 with a gap and a reaction mixture 10 is applied to the inner surface of the lower outerlayer 11 with a curtain coating apparatus 100. The curtain coating apparatus 100 is connected via a feed connection 12 to a mixing head 19 and at least the components polyol and isocyanate are introduced in the mixing head 19 in an appropriate mixing ratio represented by two arrows, wherein a possible air loading of the reaction mixture 10 may be provided but is not shown for the sake of simplicity.

The curtain coating apparatus 100 is positioned at a distance to the double belt conveying plant 21 such that over a foaming sector the reaction mixture undergoes sufficient foaming to ensure that foaming reaches the underside of the upper outerlayer 11 and as the thus-formed composite element 1 passes through the double belt conveying plant 21 the polyurethane foam core between the two outerlayers 11 can undergo curing. Once it has passed through the double belt conveying plant 21 the endless material of the composite element 1 may be separated into individual sandwich panels (not shown).

FIG. 2 shows an example of a slot plate 14, wherein the perspective view is chosen such that the slot space 15 is visible and wherein the opposed slot plate has been removed to show the flat slot space 15. The slot plate 14 shown has cutouts 23 for receiving securing means so that two slot plates 14 can be brought together to form the curtain coating apparatus 100 and to thus complete the slot space 15.

Shown by way of example is a feed connection 12 for supplying reaction mixture 10, wherein the feed connection 12 is in fluid communication with a feed channel 16 which has been incorporated into the slot plate 14. After an intermediate channel 24 for connection to the feed connection 12 the feed channel 16 branches to both sides of a transverse direction Q so that the feed channel 16 comprises two branches which extend laterally away from the feed connection 12.

A symmetrical configuration of the curtain coating apparatus is thus shown merely by way of example and said apparatus may alternatively also be formed asymmetrically on only one side of the feed connection 12 so that only one branch of the feed channel 16 connects to the feed connection 12.

The lower edge of the slot plate 14 forms a discharge slot 13 together with the further slot plate 14 (not shown). The discharge slot 13 extends in its length over the transverse direction Q between the two ends of the feed channel 16 and the feed channel 16 has a curvature such that it approaches the edge of the discharge slot 13 with increasing distance from the feed connection 12 and finally terminates therewith at its end. Thus the greater the distance from the feed connection 12, the smaller the height of the slot space 15 in the vertical direction H. The feed channel 16 itself has been incorporated into the slot plate 14 as a groove-like depression and has a channel cross section 17 which narrows as the distance from the feed connection 12 increases.

The changing channel cross section 17, the curvature in the feed channel 16 and thus the changing height in the vertical direction H of the slot space 15 are matched to one another such that the reaction mixture 10 experiences the same passthrough time through the curtain coating apparatus 100 over the entire length of the discharge slot 13 and the discharge velocity of the reaction mixture 10 from the discharge slot 13 is likewise identical over the length of the entire discharge slot 13.

FIG. 3 shows a cross sectional view through the curtain coating apparatus 100 with cross sectioned slot plates 14. Visible here is a slot space 15 which extends between the two slot plates 14 and extends in the vertical direction H from the feed channel 16 to the discharge slot 13 on the underside. The slot space 15 has a constant width B over its areal extent and the areal extent extends between the feed channel 16 and the discharge slot 13 in the vertical direction H and the transverse direction Q which is perpendicular to the vertical direction H.

FIG. 3a shows a modified embodiment of the discharge slot 13 having slot lips 26 formed thereupon, wherein the slot lips 26 protrude over the plate end of the slot plates 14 and form thin lip-like projections. This prevents reaction mixture from being able to collect in the outer region of the discharge slot 13 which in the case of larger accumulated amounts could disrupt the discharging of the reaction mixture at the outer surface of the slot plates 14.

FIG. 4 shows a perspective view of the plant used in the process according to the invention comprising a single curtain coating apparatus 100 for applying a foaming reaction mixture but showing only the application region of the reaction mixture 10 onto the lower outerlayer 11 that is relevant for the invention. The outerlayer is passed through underneath the curtain coating apparatus using the conveying rollers 33, provided with reaction mixture there and subsequently enters the double belt conveying plant 21 in the conveying direction T.

The opposite slot plate 14 facing the mixing head 19 is not shown in the figure in order to show the flat slot space 15. The slot plate 14 shown has cutouts 23 for receiving securing means so that two slot plates 14 can be brought together to form the curtain coating apparatus 100 and to thus complete the slot space 15.

Via the feed connection 12 the reaction mixture 10 is introduced through an intermediate channel 24 into the two symmetrical branches of the feed channel 16. In this case the feed channel has a circular cross section and has been incorporated into both slot plates symmetrically with a semicircular cross section in each case. The cross section of the feed channel is greatest in the region of the feed connection.

In the case of a circular cross section the ratio of the cross sectional area of the channel to the circumference—typically referred to as hydraulic diameter—is minimal, thus retarding blockage of the distributor channel at the channel end due to the wall adhesion of the reactive mixture and the decreasing velocity. Any other cross section shape, and in particular square cross sections, would be more disadvantageous in this respect.

To simplify manufacture and to facilitate cleaning the slot space 15 has been incorporated exclusively into the slot plate shown and has a constant width B over its entire areal extent between the feed channel above and the discharge slot 13 at the lower edge of the slot plate 14. The maximum height of the slot space is in the middle below the feed connection 12 and the intermediate channel 24. The discharge slot 13 extends over the transverse direction Q between both ends of the feed channel 16. The feed channel 16 has a curvature such that it approaches the edge of the discharge slot 13 with increasing distance from the feed connection 12 and finally terminates therewith at its end. At the end the feed channels 16 merge with the discharge slot in the exemplary embodiment. The cross section of the channels was made slightly larger than the width of the slot space in order to reduce the risk of blockage as a result of the chemical reaction of the mixture.

The changing cross section and the curvature in the feed channel 16 and thus the changing height in the vertical direction H of the slot space 15 were matched to one another such that the reaction mixture 10 experiences the same passthrough time through the curtain coating apparatus 100 over the entire length of the discharge slot 13 and the discharge velocity of the reaction mixture 10 from the discharge slot 13 is likewise identical over the length of the entire discharge slot 13.

As is shown in the exemplary embodiment depicted in FIG. 4 the curtain coating apparatus 100 is secured to a slide rail 34 via two lateral holders 28. The holders 28 allow for tilting of the nozzle around an axis parallel to the transverse direction Q. Tilting makes it possible to adjust the angle between the discharge film and the outerlayer 11 such that optimal flow conditions for the reaction mixture in the impact region are achieved. The slide rail 34 is displaceable on the crossmember 32 in the transverse direction Q in order to adapt the position of the discharge slot of the curtain coating apparatus to the position of the lower outerlayer 11. The distance to the crossmember and thus the distance of the discharge slot 13 of the curtain coating apparatus above the outerlayer may be chosen in the gravitational direction 9 via the two distance adjustment means 31 such that the reaction mixture is applied to the lower outerlayer in the desired manner and width. The two distance adjustment means 31 are movably mounted in the conveying direction T of the outerlayer on two lateral guide rails 29 which are secured to the plant table 30.

By displacement of the distance adjustment means 31 along the guide rails 29 the position of the curtain coating apparatus 100 in relation to the double belt conveying plant 21 can be chosen such that along the foaming sector shown in FIG. 1 the reaction mixture 10 reaches the underside of the upper outerlayer 11 in the desired manner as a result of the foaming.

### EXAMPLES

### Reactants:

| | |
|---|---|
| Polyol formulation | |
| Stepanpol PS-2352 | Polyester from Stepan having an OHN of 240 mg KOH/g based |
| | on diethylene glycol and phthalic anhydride, functionality 2, acid |
| | number 1.0 |
| Levagard PP | Tris(2-chloropropyl) phosphate (Lanxess) |
| Tegostab B 8421 | Stabilizer comprising polydimethylsiloxane and polyoxyalkylene |
| | structural elements (Evonik) |
| Water | |
| Desmorapid 1792 | Preparation of 25% by weight potassium acetate and 75% by |
| | weight diethylene glycol (Covestro) |
| Desmorapid 726b | Dimethylcyclohexylamine (Covestro) |
| Solstice LBA | Trans-1-chloro-3,3,3-trifluoropropene (Honeywell) |
| c-/i-pentane 30/70 | Mixture of 30% by weight cyclopentane and 70% by weight |
| | isopentane, Julius Hoesch Duren GmbH & Co KG |
| Isopentane | 2-methylbutane (Julius Hoesch Düren GmbH & Co KG) |
| Isocyanate | |
| Desmodur 44V70L | Polymeric MDI having a viscosity of 600-750 mPas and an NCO |
| | content between 30.5% and 32% by weight |

### Determination of Properties:

Cream time: Time characterized by commencement of foaming of the reaction mixture (visual inspection)

Fiber time: The fiber time is determined by dipping a wooden stick into the polyurethane reaction mixture and withdrawing it again. It characterizes the time, measured from the time of mixing of the reaction components, from which the mixture starts to cure. This is the time at which it is first possible to draw out strings between the wooden stick and the reaction mixture.

### Production and Evaluation of the Composite Elements:

Examples 1, 2 and 5 employed a double conveyor belt plant (DCB) having a conventional fixed application system (fixed rake applicator FPR 25.1-0 from Covestro, optimized for discharge amounts between 20 and 30 kg/min and a panel width of 1000 mm).

Inventive examples 3, 4 and 6 employed an inventive curtain coating apparatus according to FIG. 4 as the application apparatus. The length of the slot was 100 cm and the distance between the slot and the lower outerlayer was adjusted such that an optimal covering of the lower outerlayer was achieved.

Sandwich elements of 80 mm in thickness were produced by the double belt process with aluminum foil “Aluminiumfolie HYDRO1200-N, lackiert, EP” from Hydro Aluminium Rolled Products GmbH as outerlayers of 0.05 mm in thickness on both sides. The polyol formulation containing all components except for the isocyanate was mixed with the isocyanate in a linear mixing head at 140 bar. The reaction mixture was passed from the mixing head to the respective discharge apparatus via a connecting hose. The flowable starting material was supplied centrally (at 25° C. in examples 1-4 and at 23° C. in examples 5 and 6).

To evaluate the foam surface the outerlayer is removed and the surface of the panel is subjected to a visual examination. A “+” denotes that the foam contains no voids or bubbles and is homogeneous. A “−” denotes that confluence zones in which the cells have a coarser structure are clearly apparent.

Adhesion was evaluated qualitatively by manual peeloff of the outerlayer. A score of “1” denotes a very good adhesion, “2+” an almost still very good adhesion etc., while virtually no adhesion is denoted by a score of “6”.

Evaluation of fire characteristics (foam edge flaming) was carried out according to EN ISO 11925-2:2010 (German version).

Table 1 summarizes the employed amounts (in % by weight), parameters of the examples and evaluation of the composite elements produced.

TABLE 1

| Example | | 1 | 2 | 3 | 4 | 5 | 6 |
|---|---|---|---|---|---|---|---|
| Stepanpol PS-2352 | | 23.44 | 23.39 | 23.44 | 23.39 | 22.39 | 22.39 |
| Levagard PP | | 4.51 | 4.50 | 4.51 | 4.50 | 4.31 | 4.31 |
| Tegostab B 8421 | | 0.60 | 0.60 | 0.60 | 0.60 | 0.57 | 0.57 |
| Water | | 0.36 | 0.36 | 0.36 | 0.36 | 0.34 | 0.34 |
| Desmorapid 1792 | | 0.81 | 0.96 | 0.81 | 0.96 | 0.78 | 0.78 |
| Desmorapid 726b | | 0.21 | 0.30 | 0.21 | 0.30 | 0.20 | 0.20 |
| Desmodur 44V70L | | 65.10 | 64.95 | 65.10 | 64.95 | 62.18 | 62.18 |
| Solstice LBA | | | | | | 9.23 | 9.23 |
| c-/i-pentane 30/70 | | 4.96 | 4.95 | 4.96 | 4.95 | | |
| Isocyanate index | | 313 | 313 | 313 | 313 | 313 | 313 |
| Cream time | s | 6 | 3 | 5 | 3 | 5 | 5 |
| Fiber time | s | 31 | 19 | 28 | 21 | 30 | 31 |
| Foam edge flaming | mm | 148 | 147 | | | 103 | |
| Foam appearance | | + | − | + | + | − | + |
| top side | | | | | | | |
| Adhesion after | | 2+ | 2+ | 2+ | 2 | 2+ | 2+ |
| 24 h top side | | | | | | | |
| Adhesion after | | 2 | 2 | 2 | 1 | 3 | 2 |
| 24 h bottom side | | | | | | | |
| Belt speed (actual) | [m/min] | 7.1 | 10.75 | 7.6 | 10.6 | 7.13 | 7.8 |
| Total discharge | [kg/min] | 19.20 | 28.80 | 19.20 | 28.80 | 19.20 | 19.20 |
| Air loading | [Standard | 1 | 1 | 3 | 3 | 1 | 3 |
| | liters/min] | | | | | | |

List of reference symbols

| | |
|---|---|
| 100 | Curtain coating apparatus |
| 1 | Composite element |
| 10 | Reaction mixture |
| 11 | Outerlayer |
| 12 | Feed connection |
| 13 | Discharge slot |
| 14 | Slot plate |
| 15 | Slot space |
| 16 | Feed channel |
| 17 | Channel cross section |
| 19 | Mixing head |
| 20 | Outerlayer roll |
| 21 | Double belt conveying |
| | plant |
| 23 | Cutout |
| 24 | Intermediate channel |
| 26 | Slot lip |
| 28 | Tilt angle adjustment |
| | means |
| 29 | Guide rail |
| 30 | Plant table |
| 31 | Distance adjustment |
| | means |
| 32 | Crossmember |
| 33 | Conveying rollers |
| 34 | Slide rail |
| Q | Transverse direction |
| H | Vertical direction |
| B | Width |
| T | Conveying direction |
| g | Gravitational direction |

1. A process for producing polyurethane (PUR) and polyurethane/polyisocyanurate (PUR/PIR) rigid foams, comprising the steps of:
i) producing a reaction mixture comprising the components:
A) an isocyanate-reactive component comprising at least one polyol selected from the group consisting of polyether polyols, polyester polyols, polycarbonate polyols, polyether-polycarbonate polyols, and polyether ester polyols;
B) a polyisocyanate component; and
C) a blowing agent; and
ii) applying the reaction mixture with a plant comprising at least one curtain coating apparatus,
wherein the at least one curtain coating apparatus comprises:
a feed connection for introducing the reaction mixture;
at least one discharge slot extending in a transverse direction for discharging the reaction mixture;
two opposing slot plates, wherein a slot space extends between the slot plates in a vertical direction above the discharge slot; and
a feed channel connected to the feed connection which is formed between the slot plates and closes the slot space above the discharge slot in the vertical direction, wherein the feed channel has a channel cross section comprising a principal dimension greater than a width of the slot space so that the reaction mixture is introduceable into the slot space distributed over a length of the feed channel.

2. The process of claim 1, wherein the process is performed continuously.

3. The process of claim 1, wherein the channel cross section decreases with increasing distance from the feed connection.

4. The process of claim 1, wherein the at least one curtain coating apparatus is provided with a replaceable insert made of plastic, metal or another material which protects the inside of the slot plates of the curtain coating apparatus from contamination.

5. The process of claim 1, wherein over at least a partial width of an outerlayer, the plant comprises a plurality of curtain coating apparatuses, wherein the discharge slots of the curtain coating apparatuses extend in a common transverse direction or arcuately over the outerlayer.

6. The process of claim 1, wherein each individual curtain coating apparatus used in the plant or else the entire plant is configured such that the distance thereof from the lower outerlayer may be varied during application of the reaction mixture.

7. The process of claim 1, wherein in each case based on the total weight of the isocyanate-reactive component A), the isocyanate-reactive component A) comprises:
a) 65% to 100% by weight of at least one of a base polyol component selected from the group consisting of polyester polyol, polyether polyol, polyether ester polyol, polycarbonate polyol, and polyether-polycarbonate polyol having a hydroxyl number in a range of 100 to 300 mg KOH/g and functionalities of ≥1.2 to ≤3.5;
b) 0% to 25% by weight of long-chain polyether polyols having functionalities of ≥1.2 to ≤3.5 and a hydroxyl number in a range of 10 to 100 mg KOH/g;
c) 0% to 10% by weight of low molecular weight isocyanate-reactive compounds having a molar mass Mₙ of less than 400 g/mol; and
d) 0% to 10% by weight of medium-chain polyether polyols having functionalities of ≥2 to ≤6 and a hydroxyl number in a range of 300 to 700 mg KOH/g.

8. The process of claim 1, wherein based on the total weight of the isocyanate-reactive component, the isocyanate-reactive component A) comprises:
a) 65-100% by weight of at least one polyester polyol having a functionality of functionalities of ≥1.2 to ≤3.5, a hydroxyl number in a range of 100 to 300 mg KOH/g, and an acid number in a range of 0 to 5.0 mg KOH/g; and
b) 0% to 10% by weight of a polyether polyol having a functionality of ≥1.8 to ≤3.5 and a hydroxyl number in a range of 10 to 100 mg KOH/g.

9. The process of claim 16, wherein the catalyst component D) comprises an aminic catalyst D1) and a carboxylate D2), and the D2/D1 quantity ratio is between 0.1 and 80.

10. The process of claim 1, wherein a cream time of the reaction mixture is <5 seconds.

11. The process of claim 1, wherein a fiber time of the reaction mixture is <25 seconds.

12. The process of claim 1, wherein the blowing agent C) is a physical blowing agent comprising one or more compounds selected from the group consisting of hydrocarbons, halogenated ethers, and (per)fluorinated hydrocarbons.

13. The process of claim 1, wherein step ii) comprises applying a foaming mixture.

14. A PUR rigid foam or PUR/PIR rigid foam produced by the process of claim 1.

15. A composite element comprising one or two outerlayers and the PUR or PUR/PIR rigid foam of claim 14.

16. The process of claim 1, wherein the reaction mixture further comprises D) a catalyst component.

17. The process of claim 1, wherein the reaction mixture further comprises E) assistant and additive substances.

18. The process of claim 12, wherein the physical blowing agent comprises one or more compounds selected from the group consisting of pentane isomers and (hydro)fluorinated olefins.

19. The process of claim 9, wherein the D2/D1 quantity ratio is between 2 and 20.
